(19) United States
(12) Patent Application Publication
(10) Pub. No.: US 2010/0145668 A1
(43) Pub. Date: Jun. 10, 2010

(54) METHOD FOR DYNAMIC REPARTITIONING IN ADAPTIVE MESH PROCESSING

(76) Inventors: MARK S. FISHER, Bridgeton, MO (US); MORTAZA MANI, St. Louis, MO (US)

Correspondence Address: Hayes Soloway P.C., 3450 E. Sunrise Drive, Suite 140, Tucson, AZ, 85718, US

(21) Appl. No.: 12/328,607

(22) Filed: Dec. 4, 2008

(51) Int. Cl. G06G 7/48

(52) U.S. Cl. 703/6

(57) ABSTRACT

A method for dynamic repartitioning of a mesh, wherein the mesh is partitioned to find a solution using a plurality of processors, and wherein the partitions have become unbalanced. The present method allows large portions of the mesh to continue to progress towards a solution by only repartitioning a small percentage of the overall mesh. This is done by stripping cells along the partition interfaces using a marching method to form a free-cell region, repartitioning the free-cell region, and joining the repartitioned portions of the free-cell region with the remaining cells in a manner that will increase the efficiency of the solver.

### FIELD

The present disclosure is generally related to methods for dynamic partitioning of a mesh. The invention has particular utility for use with processing of computational fluid dynamics (CFD) models and will be described in connection with such utility, although other utilities are contemplated.

### BACKGROUND

The Fluid Dynamic governing equations for complex configurations are not generally amenable to analytical solutions. Instead, these and other similar problems are usually solved by dividing the simulation into a mesh of discrete domains, wherein the governing equations are solved inside each of these portions of the domain. Each of these portions of the domain are known as elements or cells, and the collection of all elements is known as mesh or grid.

To make solution of large meshes feasible, the meshes are partitioned to allow individual solutions to run in parallel on many processors in order to obtain a solution in a timely manner. To increase solution accuracy, the mesh undergoes adaptation, often referred to as Adaptive Mesh Refinement (AMR), by locally refining and coarsening the mesh to improve the resolution of the mesh around phenomena of interest without an excessive increase in computational effort. For example, highly refined meshes are required to accurately model flow physics and compute desired functions such as drag, lift, moments, and other flow phenomena including shock waves and vortices.

In order to run efficiently, however, the load on each processor must be the same. The adaptive solution causes the load to become unbalanced among parallel processors, and therefore decreases the efficiency of the parallel solution by orders of magnitude.

Solutions address this problem by repartitioning the mesh to balance the loads between processors. Solutions typically include an evaluation step to determine if the adaptive mesh is sufficiently unbalanced to warrant a repartitioning. Where repartitioning is justified, the adapted mesh typically is divided into new subgrids and reassigned to new processors in a manner that will minimize the cost of data movement. Another evaluation step determines if the remapping cost is less than the computational gain that would be achieved through balanced partitions.

The remapping cost of these methods are very high because the repartitioning method is not truly dynamic. Current methods require operator input before essentially starting over and repartitioning the mesh from scratch. The remapping costs of these methods typically include saving the solution and retransmitting all the data again on restart. These constraints typically make it infeasible to repartition the mesh until the imbalance becomes quite large.

### SUMMARY

The present disclosure improves over the prior art by providing a method for dynamic repartitioning that allows a solver to continue to run while facilitating a quick rebalance of the load on each processor.

One aspect of the present disclosure provides a method for dynamic repartitioning of a mesh that is partitioned to be solved on a plurality of processors in parallel, comprising: identifying the interfaces in each partition; creating super-cells from the original partitions, a remainder forming a free-cell region; repartitioning the free-cell region into a plurality of portions; and combining each one of the super-cells with a portion of the repartitioned free-cell region to form a plurality of new partitions.

Another aspect of the present disclosure provides a method for finding a solution to a large-scale numerical simulation, comprising: forming a mesh; placing partitions in the mesh to run the simulation on a plurality of processors; executing an iterative solver to find the solution; and periodically rebalancing the partitioned mesh with a dynamic repartitioning method.

Other systems, methods, features, and advantages of the present disclosure will be or become apparent to one with skill in the art upon examination of the following drawings and detailed description. The features, functions and advantages that have been discussed can be achieved independently in various embodiments of the present invention or may be combined in yet other embodiments further details of which can be seen with reference to the following description and drawings.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a flowchart demonstrating a method for finding a solution to a large-scale numerical simulation;

FIG. 2 is a flowchart demonstrating a method for dynamic domain repartitioning in accordance with the present disclosure; and

FIGS. 3A-3F are illustrations showing a mesh at different stages of the steps shown in FIG. 2.

### DETAILED DESCRIPTION

The present disclosure provides a method for dynamic decomposition and repartitioning of a large-scale numerical simulation, where the simulation employs a mesh that has been partitioned to run on a plurality of processors in parallel.

A primary example of a large-numerical simulation that fits this description is a Computational Fluid Dynamics (CFD) model. Other candidates include, for example, Computer-aided Engineering (CAE) tasks that employ partitioned grids to run on parallel processors, such as Finite Element Modeling (FEM). The present disclosure is intended to include these examples and any other numerical analysis that employ a mesh that is partitioned to run on parallel processors.

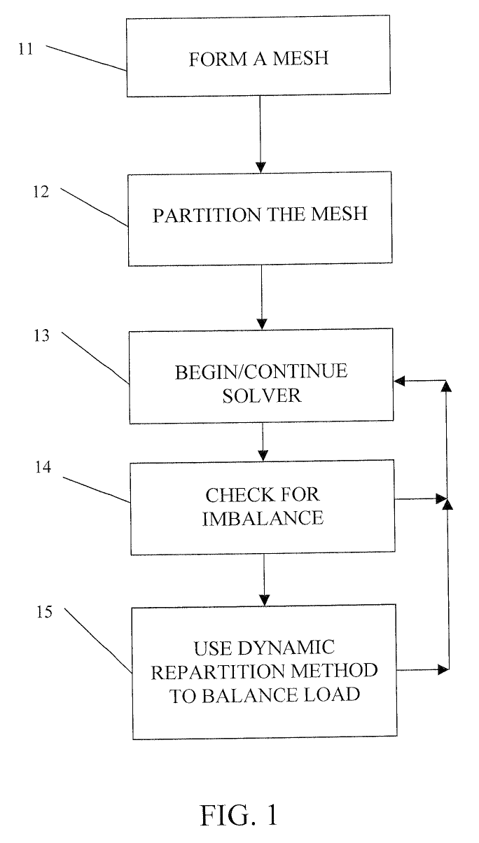

Referring to FIG. 1, one aspect of the present disclosure provides a method for finding a solution to a large-scale numerical simulation using parallel processors, comprising forming a mesh to represent the simulation 11; partitioning the mesh to run on parallel processors 12; beginning the solver 13; periodically checking for imbalance between the partitions of the mesh 14, wherein if an imbalance is found, a dynamic repartitioning method is used to repartition the mesh and rebalance the load 15; and continuing the solver 13.

The simulation must be one that can be represented in a mesh, Meshes are appropriate when solving a large numerical problem that is not suitable for numerical analysis methods and must be solved by iteration. The mesh may be of any shape and may be structured or unstructured.

Complex meshes are commonly partitioned to be solved on several processors in parallel. The partitions usually divide the mesh into equal portions to balance the load between the parallel processors. The present method may use any solver that is compatible with the circumstances described in this disclosure.

This invention will allow efficient dynamic rebalancing of the work if the load becomes imbalanced for any reason. Currently mesh adaptation is the main driver for such an imbalance, but there are other events that could also cause the work to become imbalanced.

There are several appropriate triggering mechanisms for beginning the dynamic repartitioning method. The method may be scheduled to run at a particular time interval or after a certain number of operations have been completed. If the load is balanced at the planned time interval, or if the load is within a chosen range of a balanced load, the repartitioning of the mesh should be aborted.

Alternatively, the method for dynamic repartitioning of the mesh may be triggered by a measure of the load on each processor. Under this control scheme, the repartitioning method would be started whenever the load becomes unbalanced beyond a chosen threshold. Another alternative method is to allow a user to trigger the dynamic repartitioning method.

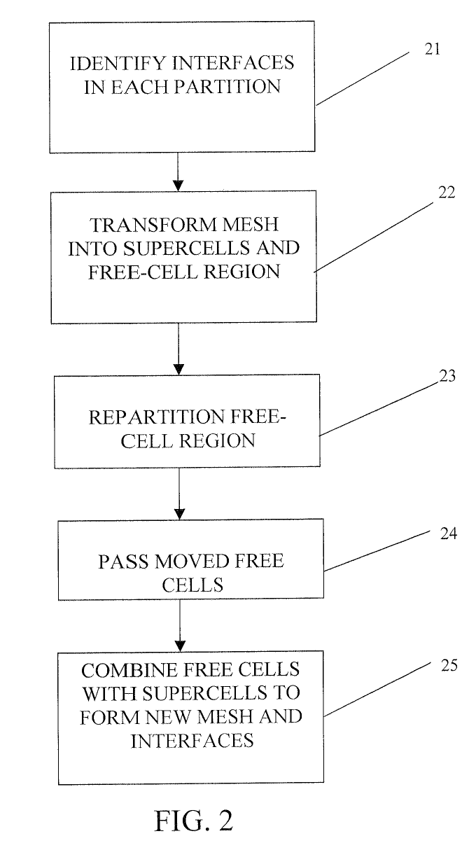

Referring to FIG. 2, another aspect of the present disclosure presents a method for dynamic repartitioning of a mesh for solving a large-scale numerical simulation, comprising identifying the interfaces in each partition 21; creating super-cells from the original partitions, a remainder forming a free-cell region 22; partitioning the free-cell region 23; and passing moved free-cells to the respective processor 24 to combine with the super-cells and form a new partition 25.

The original mesh may be partitioned using any available means prior to running the solution as the original partition is created statically. Once the solver is running, the present method requires some means for identifying the interfaces in each partition. As with the static partitioning, these means are known to those with skill in the art. Super-cells are created from the original partitions. In one embodiment, the super-cells may be created and the free-cell region may be formed by stripping cells from the edges of the partition interfaces. In another embodiment, the free-cell region may be created by stripping cells from each partition according to a marching method from interfaces. The free-cell region is then partitioned using an appropriate algorithm and recombined with the corresponding super-cells to create a new partition scheme that is balanced.

The method of the present disclosure is advantageous over the prior art because the super-cells remain with the corresponding processors and the moved free-cells make up a small percentage of the total cells. The number of interfaces remains the same. Thus, instead of retransmitting the entire grid and solution on restart, the present method only requires exchanging the moved data in parallel to the other processes. This will minimize the cost of performing the repartitioning and ultimately result in faster solutions.

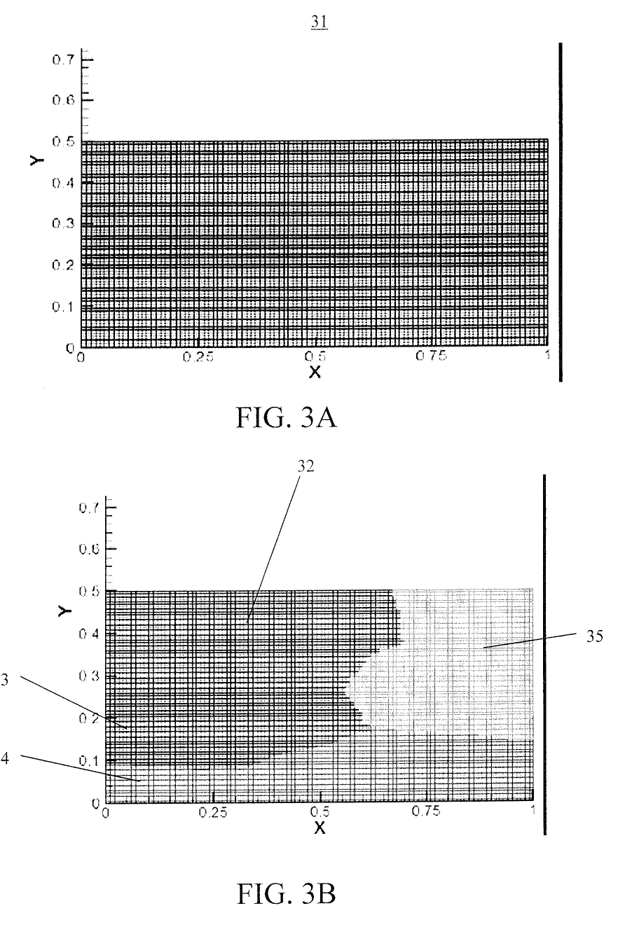

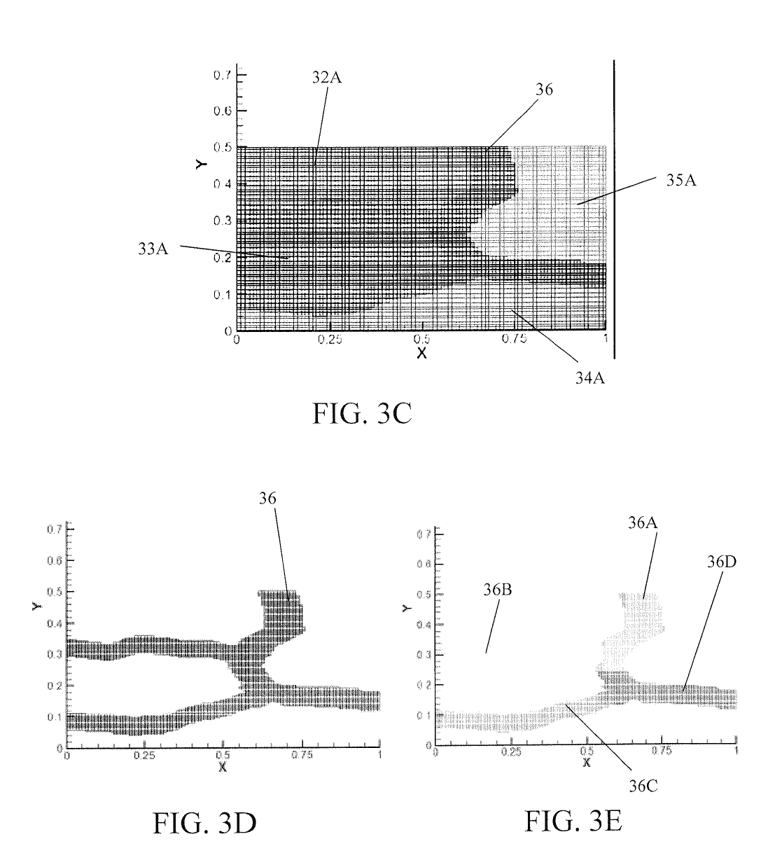

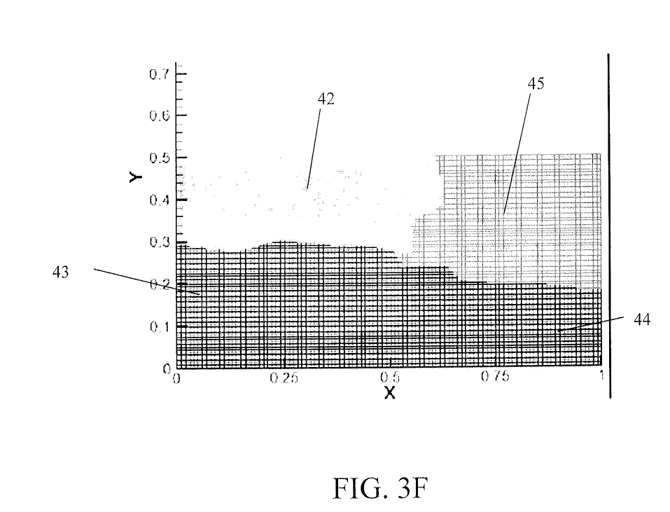

The steps of the present method are illustrated in FIGS. 3A-3F. FIG. 3A displays the example mesh in its original form 31. While the figure shows a 2-dimensional mesh, the method of the present disclosure may also be 3-dimensional. The method of the present disclosure is also equally suitable for use with structured and unstructured meshes of any shape or coordinate system.

The mesh is then partitioned, as shown in FIG. 3B. In the current study the starting mesh is partitioned into four balanced cell regions 32-35, though this is not necessary for the current method to be effective. In a specific application, particularly where some initial adaptation may be anticipated, an unbalanced mesh may be used from the onset.

As mentioned above, the method of the present disclosure works with any numerical solver that employs a mesh to reach an iterative solution. The method is preferably used with an adaptive mesh, where the load becomes unbalanced over time. A primary example of this is a Computation Fluid Dynamics mesh, where the partial differential equations are not suited for analytical methods. The mesh adaptation strategy does not affect the method of the present disclosure. Thus, r-refinement, h-refinement, or p-refinement, or any other mesh adaptation strategies may be used with the present disclosure and achieve satisfactory results. The simplified example mesh in FIGS. 3A-3F does not show evidence of any adaptation, but once the solver starts the mesh may adapt to accurately capture flow features.

At a chosen point in the solution, a marching method may be used to strip off the outer layer of a partition based on its load imbalance. For each individual partition, this is the layer that interfaces with other partitions. The result of this step is shown in FIG. 3C. The remainder of each partition is referred to herein as a super-cell 32A, 33A, 34A, 35A. The point in time at which the repartitioning occurs may be pre-determined according to the amount of time elapsed, the changing balance of the loading of the processors, a chosen number of iterations have taken place, a user input is received, or any other desired parameter.

The mesh points at the edge of each super-cell that require input from those cells which had been stripped away will retain their value, allowing the solution to continue to run within each super-cell. This reduces the cost of the repartitioning procedure, allowing a more efficient solution to be achieved.

According to the present disclosure, the stripped data forms a free-cell region 36 that is preferably only 10-20 percent of the entire solution, though larger or smaller amounts may be chosen by for a specific application. Additionally, this parameter may be measured in percentage of the entire solution, in percentage of each partition individually, in the grid size of the mesh, or any other fraction of a known parameter measuring the grid or individual partitions. Alternatively, the fraction from each partition may be chosen to create super-cells of the same size.

FIG. 3D isolates the free-cell region 36. The outer layers of each partition, along with the partitions core (the super-cells), are repartitioned to correct the load imbalance. In this specific example, the data is repartitioned into equally sized regions 36A, 36B, 36C, 36D because each super-cell is equal in size. The repartitioned free-cell region is shown in FIG. 3E. In other instances, the sizes of each of the repartitioned portions of the free-cell region may be chosen to form new partitions that are balanced. For example, the repartitioning of the free-cell region may be unbalanced with the intent of combining with the super-cells to create partitions of equal size. In other embodiments, the repartitioning may be unbalanced to create an unbalanced partition if desired. The number of free-cells which are moved from one processor to another will likely be far less than the overall size of the free-cell region.

As mentioned above, the method does not require a substantial amount of time compared to prior art methods because the repartitioning of the free-cell region is on a much smaller subset of the original grid. Thus, the present disclosure advantageously progresses towards a numerical solution while minimizing the limitations of the repartitioning procedure and ultimately arriving at a more efficient partition configuration.

The method of the present disclosure allows the use of many partitioning methods based on graph theory. Other algorithms, such as those deploying multilevel diffusion, scratch-remap, wavefront diffusion, spectral load balancing, or other schemes, may be used with the present disclosure. For example, the free-cell region may be repartitioned using a method or algorithm as mentioned above, or any combination thereof.

The partitioned portions of the free-cell region are then transmitted to and joined with the receiving partition (super-cell). See FIG. 3F. The partitioned portions are preferably matched to a super-cell that is adjacent, or which has the longest common edge, in order to reduce the amount of information that must be exchanged between processors.

The new partition in the present example results in four balanced regions 42, 43, 44, 45. In the present example, because both the beginning and final partitions are equally balanced, FIGS. 3B and 3F may be compared visually to further demonstrate that the final partition is equally balanced.

In comparison with the prior art, this process is much more efficient since it preferably operates on only 10-20 percent of the full mesh and the solver does not have to stop and restart. Thus, the costs associated with repartitioning are significantly minimized in comparison with the prior art. Because the cost of the repartitioning is low, this operation can be performed before the load imbalance overwhelms the hardware.

It should be emphasized that the above-described embodiments of the present disclosure, particularly, any “preferred” embodiments, are merely possible examples of implementations, merely set forth for a clear understanding of the principles of the present disclosure. Many variations and modifications may be made to the above-described embodiments without departing substantially from the spirit and principles of the disclosure. All such modifications and variations are intended to be included herein within the scope of this disclosure and protected by the following claims.

What is claimed is:

1. A method for dynamic repartitioning of a mesh that is partitioned to be solved on a plurality of processors in parallel, comprising:
identifying the interfaces in each partition;
creating super-cells from the original partitions, a remainder forming a free-cell region;
repartitioning the free-cell region into a plurality of portions; and
combining each one of the super-cells with a portion of the repartitioned free-cells region to form a plurality of new partitions.

2. The method of claim 1, wherein the simulation is a computational fluid dynamics model.

3. The method of claim 1, wherein the simulation is a finite element model.

4. The method of claim 1, wherein the mesh is an adaptive mesh.

5. The method of claim 1, wherein the super-cells are created and the free-cell region is formed by stripping cells from the edges of each of the partition interfaces.

6. The method of claim 5, wherein the cells are stripped using a marching method.

7. The method of claim 1, wherein the free-cell region is 10-20% of the size of the overall mesh.

8. The method of claim 1, wherein each of the super-cells are the same size.

9. The method of claim 1, wherein each of the super-cells continue to progress to a solution.

10. The method of claim 1, wherein the free-cell region is repartitioned using a method from the group consisting of: multilevel diffusion, scratch-remap, wavefront diffusion, spectral load balancing, or a combination thereof.

11. The method of claim 1, wherein the sizes of each of the repartitioned portions of the free-cell region are chosen to form new partitions that are balanced.

12. The method of claim 1, wherein the super-cells are combined with an adjacent repartitioned portion of the free-cell region.

13. A method for finding a solution to a large-scale numerical simulation, comprising:
forming a mesh;
placing partitions in the mesh to run the simulation on a plurality of processors;
executing an iterative solver to find the solution; and
periodically rebalancing the partitioned mesh with a dynamic repartitioning method.

14. The method of claim 13, wherein the simulation is a computational fluid dynamics model.

15. The method of claim 13, wherein the simulation is a finite element model.

16. The method of claim 13, wherein the mesh is an adaptive mesh.

17. The method of claim 13, wherein the partitioned mesh is periodically rebalanced at a particular time interval.

18. The method of claim 17, wherein the dynamic repartitioning method is aborted if the load on the processors is balanced.

19. The method of claim 13, wherein the partitioned mesh is periodically rebalanced when the load between processors becomes unbalanced.

20. The method of claim 13, wherein the partitioned mesh is periodically rebalanced using the method of claim 1.
